(19) United States
(12) Patent Application Publication
(10) Pub. No.: US 2026/0274237 A1
(43) Pub. Date: Sep. 17, 2026

(54) ACTUATOR ASSEMBLY FOR AN ELECTROMECHANICAL VEHICLE BRAKE

(71) Applicant: ZF Active Safety GmbH, Koblenz (DE)

(72) Inventor: Volker Knop, Ulmen (DE)

(21) Appl. No.: 19/557,233

(22) Filed: Mar. 5, 2026

(30) Foreign Application Priority Data
Mar. 11, 2025 (DE) 102025109282.6

(51) Int. Cl. B60T 13/74

(52) U.S. Cl. CPC B60T 13/746

(57) ABSTRACT

An actuator assembly for an electromechanical vehicle brake has a brake calliper, a spindle drive, which has a spindle sleeve, a spindle nut and a drive shaft, driven by an electric motor, for adjusting the spindle nut in the axial direction via the spindle sleeve, a brake housing, which forms the brake calliper and inside which the spindle drive is arranged, and an actuator housing, which is connected to the brake housing. The drive shaft is coupled on the one hand to the spindle sleeve via a reduction gear mechanism and on the other hand to a motor shaft of an electric motor via a gear unit with spur gears, wherein all the spur gears are arranged in a common plane. Furthermore, the gear unit is arranged inside the actuator housing.

### TECHNICAL FIELD

The invention relates to an actuator assembly for an electromechanical vehicle brake.

### BACKGROUND

Actuator assemblies in vehicle brakes are used for applying a brake lining to a brake rotor. For this purpose, the actuator assembly usually has a spindle drive, which has a spindle nut and a spindle, driven by an electric motor, for axially moving the spindle nut, wherein an axial feed force for applying the brake lining to the brake rotor is transmitted from the spindle nut to the brake lining.

The electric motor, which is used to drive the spindle drive, is arranged, in terms of its drive axis, eccentrically with respect to the drive axis of the spindle drive.

Therefore, in order to couple the electric motor to the spindle drive, a single-stage gear mechanism is provided between the electric motor and spindle and additionally a planetary gear mechanism is provided on the spindle, in order for it to be possible to provide a corresponding axial feed force for applying the brake lining.

The installation space conditions in the region of actuator assemblies for electromechanical vehicle brakes are generally very confined.

Consequently, the field of application of actuator assemblies is always dependent on their installation space requirement, wherein a relatively high installation space requirement of an actuator assembly is disadvantageous.

### SUMMARY

Therefore, the object of the invention is to provide an actuator assembly for an electromechanical vehicle brake that has a particularly low installation space requirement.

The object is achieved according to the invention by an actuator assembly for an electromechanical vehicle brake, having a brake calliper in which an intermediate space for a brake rotor is formed, wherein a brake lining, which can be applied to the brake rotor, is arranged in the intermediate space, a spindle drive, which has a spindle sleeve, a spindle nut and a drive shaft, driven by an electric motor, for adjusting the spindle nut in the axial direction via the spindle sleeve, wherein the spindle nut can be moved between an extended and a retracted position by means of axial adjustment, a brake housing, which forms the brake calliper and inside which the spindle drive is arranged, and an actuator housing, which is connected to the brake housing. The drive shaft is coupled on the one hand to the spindle sleeve via a reduction gear mechanism and on the other hand to a motor shaft of an electric motor via a gear unit with spur gears, wherein all the spur gears are arranged in a common plane. In addition, the gear unit is arranged inside the actuator housing.

It has been recognized according to the invention that by this design of the gear unit the actuator assembly can be designed particularly compactly, in particular in the axial direction.

The spindle sleeve is located inside the spindle nut and drives the latter via the spindle drive, i.e. the interposed balls, for example.

According to one aspect, in at least one position of the spindle nut, the reduction gear mechanism is arranged at least partially inside the spindle nut and/or the spindle sleeve in the axial direction. The basic concept here is to reduce the installation length of the actuator assembly by using the unused installation space inside the spindle nut and/or the spindle sleeve for arranging the reduction gear mechanism, which is required for driving the spindle drive via an electric motor, at least partially inside the spindle nut and/or the spindle sleeve. Consequently, the installation space taken up by the actuator assembly is reduced and therefore installation space can be saved and, at the same time, the available installation space inside the actuator assembly itself is utilized more effectively.

The term “gear mechanism” or “reduction gear mechanism” can be considered to cover only the gearwheels or toothing portions that form the gear mechanism, without taking into account, for example, the shafts or sleeves on which the gearwheels or toothing portions are fitted. These can optionally be located partially or entirely outside the spindle nut and/or the spindle sleeve.

Furthermore, the reduction gear mechanism may be a tungsten gear mechanism, an eccentric gear mechanism or a cycloidal gear mechanism. These types of gear mechanism belong to the high-reduction gear mechanisms, by means of which the axial installation length as well as the number of components and thus mass can be saved.

In one embodiment, the gear unit is a spur gear mechanism or a belt gear mechanism, which have a particularly small number of individual parts and are designed simply and inexpensively.

In a further embodiment, a printed circuit board is arranged inside the actuator housing, said printed circuit board forming a control device of the actuator assembly. This design has the advantage that the control device of the actuator assembly is arranged in direct proximity to the spindle drive and electric motor.

Here, a partition wall can be arranged inside the actuator housing, said partition wall separating the printed circuit board from the gear unit and the electric motor in an air-tight manner in order to protect the printed circuit board.

According to one aspect, the partition wall is connected to the actuator housing via a seal, so that the printed circuit board is sealed reliably and effectively with respect to the gear unit and the electric motor.

Furthermore, it can be provided that the actuator housing has a housing body and a housing cover, which is attached to the housing body and to which the printed circuit board is fastened. In this way, the actuator assembly can be manufactured and assembled with little effort.

The actuator housing can have a connection housing, connected in one piece to the housing cover, of an electrical connection. The electrical connection has connection contacts, which are connected in a signal-transmitting manner to the printed circuit board and extend through the housing cover and the connection housing into a connection geometry of the connection housing. Because the connection housing is integrated into the actuator housing, it consists of a particularly small number of individual parts.

According to one embodiment, the connection housing is arranged on a peripheral wall of the housing cover and in the axial direction between an outer end face of the housing cover and the spindle drive. As a result, the actuator housing is designed particularly compactly, in particular in the axial direction.

It can also be provided that the connection housing is connected to the housing body via a plug-in geometry, which forms a rotation prevention means between the connection housing and the housing body. Thus, it can be ensured in a simple manner that the connection housing is rigidly coupled to the housing body, so that electrical cables with a connection geometry of a complementary shape can reliably be connected to the electrical connection with little effort.

According to a further embodiment, the plug-in geometry has at least one rib extending in the axial direction and a groove of complementary shape into which the rib engages positively. As a result, the plug-in geometry can be designed without additional components and in a particularly space-saving manner.

The plug-in geometry can have two grooves with their open sides facing each other, into which the respective associated rib engages positively, so that the rotation prevention means is particularly effective.

### BRIEF DESCRIPTION OF THE DRAWINGS

The invention will be described below on the basis of an embodiment, which is illustrated in the appended drawings, in which:

FIG. 1 shows a sectional view of an actuator assembly according to the invention having a spindle nut in a retracted position,

FIG. 2 shows an exploded view of the actuator assembly from FIG. 1,

FIG. 3 shows an exploded view of an actuator housing and a gear unit of the actuator assembly from FIG. 1,

FIG. 4 shows an exploded view of an actuator housing and a gear unit of the actuator assembly from FIG. 1 according to a variant,

FIG. 5 shows an exploded view of the actuator housing and a printed circuit board of the actuator assembly from FIG. 1,

FIG. 6 shows a sectional view of a plug-in geometry of the actuator housing from FIG. 5,

FIG. 7 shows a sectional view of a connection housing of the actuator housing from FIG. 5, and

FIG. 8 shows a sectional view of the actuator housing from FIG. 5.

### DESCRIPTION

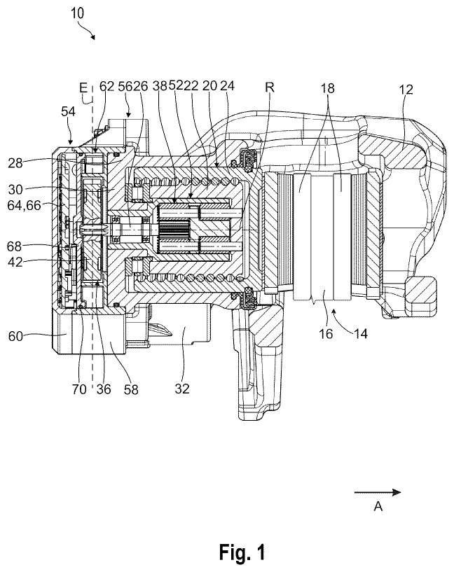

FIG. 1 shows an actuator assembly 10 for an electromechanical vehicle brake.

The actuator assembly 10 comprises a brake calliper 12, in which an intermediate space 14 for a brake rotor 16 is formed.

At least one brake lining 18, which can be applied to the brake rotor 16, is arranged on each side of the brake rotor 16 in the intermediate space 14.

In addition, the actuator assembly 10 comprises a spindle drive 20, which is a ball screw drive in the exemplary embodiment, with a rotatably mounted spindle sleeve 22, which is driven by an electric motor and on the outer shell of which a spindle nut 24 for applying the brake lining 18 to the brake rotor 16 is mounted.

Provision is furthermore made for a drive shaft 26, with a rotational axis R, which is used for driving the spindle sleeve 22, wherein the spindle nut 24 can in turn be adjusted axially, i.e. in or counter to the axial direction A, via the spindle sleeve 22.

The spindle nut 24 is adjustable between an extended and a retracted position, which is shown in FIG. 1, by means of axial displacement and is guided linearly in the brake calliper 12. The spindle sleeve 22 and spindle nut 24 are coupled together via a ball recirculation system such that, when the spindle sleeve 22 is rotated, the non-rotatable spindle nut 24 is axially adjusted.

The spindle nut 24 of the spindle drive 20 constitutes, in particular, a brake piston.

The actuator assembly 10 also has a brake housing 28, inside which the spindle drive 20 is received.

The brake housing 28 is in this case connected in one piece with the brake calliper 12.

In this context, the spindle drive 20 is arranged axially between the brake linings 18 and a base wall 30 of the brake housing 28, the spindle drive 20 being supported on said base wall counter to the axial direction A when the spindle nut 24 presses the brake lining 18 onto the brake rotor 16 in order to actuate the electromechanical vehicle brake.

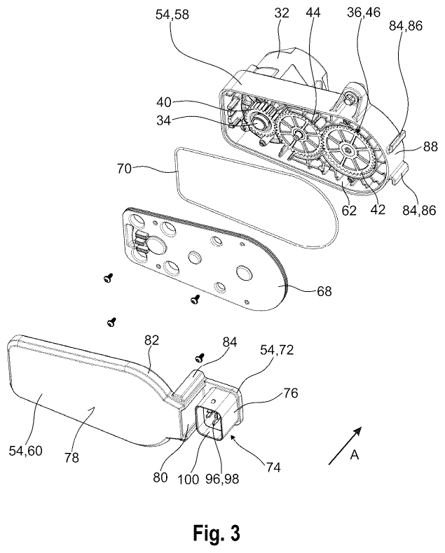

As a drive, the actuator assembly 10 comprises for this purpose an electric motor 32 with a motor shaft 34 (see FIG. 3).

The electric motor 32 is used to move the spindle nut 24 between the retracted position and the extended position.

The drive shaft 26 is coupled on the drive side to the motor shaft 34 via a gear unit 36 and on the output side to the spindle sleeve 22 via a reduction gear mechanism 38 (see FIG. 1).

The gear unit 36 has a first spur gear 40 (see FIG. 3), which is non-rotatably coupled to the motor shaft 34, and a second spur gear 42, which is non-rotatably coupled to the drive shaft 26.

The first spur gear 40 and the second spur gear 42 are coupled in the embodiment shown in FIG. 3 in a torque-transmitting manner via a third spur gear 44, which is in interlocking engagement with each of the first and second spur gears 40, 42.

The spur gears 40, 42, 44 form a spur gear mechanism 46.

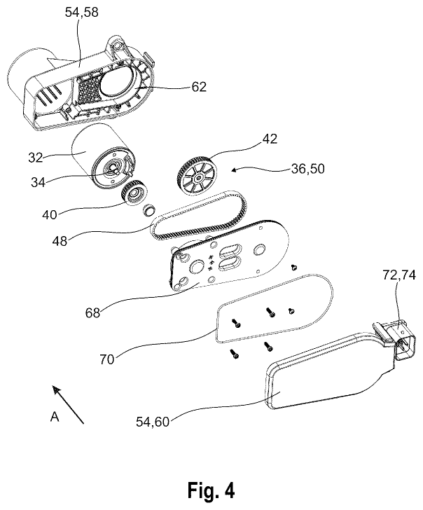

In an alternative embodiment (see FIG. 4), the first spur gear 40 and the second spur gear 42 are coupled in a torque-transmitting manner via a toothed belt 48, which is in interlocking engagement with each of the first and second spur gears 40, 42.

The spur gears 40, 42 and the toothed belt 48 form a belt gear mechanism 50.

In all embodiments, at least the first spur gear 40 and the second spur gear 42 are arranged in a common plane E (see FIG. 1), which is perpendicular to the rotational axis R of the drive shaft 26.

In the embodiment shown, the reduction gear mechanism 38 is a tungsten gear mechanism.

In an alternative embodiment, the reduction gear mechanism 38 may be any gear mechanism, for example an eccentric gear mechanism or a cycloidal gear mechanism.

In this connection, the spindle sleeve 22 has a cavity 52 inside which the reduction gear mechanism 38 is received, so that it is arranged in the axial direction at least partially inside the spindle nut 24 and the spindle sleeve 22.

According to FIG. 1, the reduction gear mechanism 38 can be arranged entirely inside the spindle sleeve 22.

Furthermore, the reduction gear mechanism 38 can also additionally be arranged entirely inside the spindle nut 24, for example when the spindle nut 24 is in the retracted position.

Alternatively, it is also conceivable that the reduction gear mechanism 38 is arranged only partially inside the spindle nut 24 and/or the spindle sleeve 22 in the axial direction A.

In this context, only the gearwheels or toothing portions are considered to be the reduction gear mechanism 38, without taking into account the shafts or sleeves on which the gearwheels or toothing portions are provided.

While the reduction gear mechanism 38 is arranged entirely inside the brake housing 28 (see FIG. 1), the gear unit 36 is arranged entirely inside an actuator housing 54, which is connected to the brake housing 28.

The gear unit 36 is thus arranged entirely outside the brake housing 28.

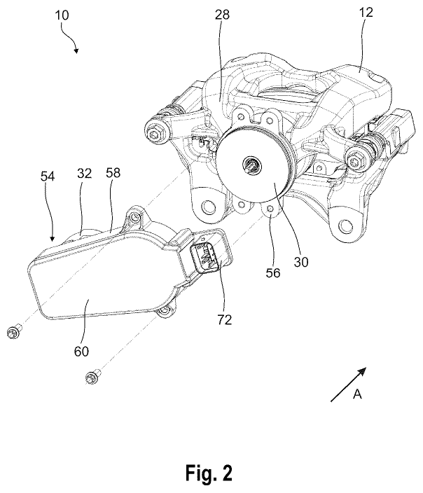

As shown in FIG. 2, the actuator housing 54 in the present embodiment is connected, for example screwed, to the brake housing 28 via a flange 56.

In principle, however, the actuator housing 54 can be connected to the brake housing 28 in any way.

The actuator housing 54 has a pot-shaped housing body 58 (see FIG. 3) and a plate-shaped housing cover 60, which is attached to the housing body 58 and, together therewith, delimits a chamber 62 (see FIG. 1) in the interior of the actuator housing 54.

For example, the actuator housing 54 is made of plastic.

The housing body 58 and the housing cover 60 are connected to each other in an air-tight manner, for example welded.

Inside the chamber 62, a printed circuit board 64 is received and fastened to the inside of the housing cover 60.

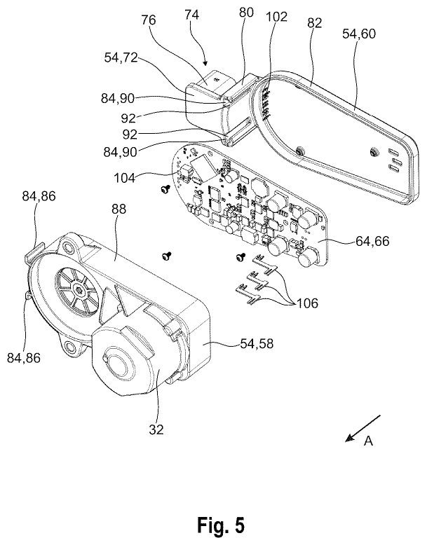

As can be seen in FIG. 5, the printed circuit board 64 can be screwed to the housing cover 60.

The printed circuit board 64 is a control device 66 of the actuator assembly 10 or part of such a control device 66.

There are integrated into the printed circuit board 64, for example, a motor position sensor, a motor controller, power electronics, a current consumption sensor for the motor current, measurement modules for the force and temperature sensors, an actuating electronics for a parking brake function and an electronic control unit (ECU) for the control of the electromechanical vehicle brake.

Furthermore, a partition wall 68 (see FIG. 3) is arranged in the chamber 62, said partition wall separating the printed circuit board 64 from the gear unit 36 and the electric motor 32 in an air-tight manner.

For this purpose, the partition wall 68 is connected to the housing body 58 via a seal 70 that extends around the entire periphery.

As can be seen in FIG. 3, the partition wall 68 can be screwed to the housing body 58.

The actuator housing 54 further has a connection housing 72, which is formed integrally with the housing cover 60 and is part of an electrical connection 74 of the actuator assembly 10.

The connection housing 72 has a socket portion 76, which is offset in the axial direction A relative to an outer end face 78 of the housing cover 60, and an axial web 80, which connects the socket portion 76 to a peripheral wall 82 of the housing cover 60. In this way, the socket portion 76 is arranged laterally next to the housing cover 60 and offset in the axial direction A towards the brake calliper 12.

Furthermore, the connection housing 72 is connected to the housing body 58 via a plug-in geometry 84.

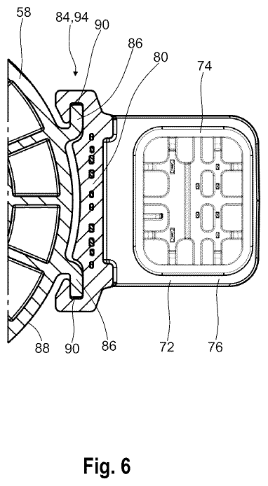

In the present embodiment, the plug-in geometry 84 is formed by two ribs 86, which extend in the axial direction A and are arranged on a peripheral wall 88 of the housing body 58, and two grooves 90 of complementary shape extending in the axial direction A (see FIG. 5), into each of which one of the ribs 86 engages positively (see FIG. 6).

In principle, the plug-in geometry 84 can be of any design.

Furthermore, in an alternative embodiment, the plug-in geometry 84 may have any number of ribs 86, for example at least one.

The grooves 90 are formed in the present embodiment in the axial web 80 of the connection housing 72.

Further, the open sides 92 of the grooves 90 face each other and the ribs 86 correspondingly extend away from each other, or in opposite directions, into the grooves 90.

In this way, the plug-in geometry 84 connects the housing body 58 and the connection housing 72 rigidly to each other and thus forms a rotation prevention means 94 (see FIG. 6) between these two components.

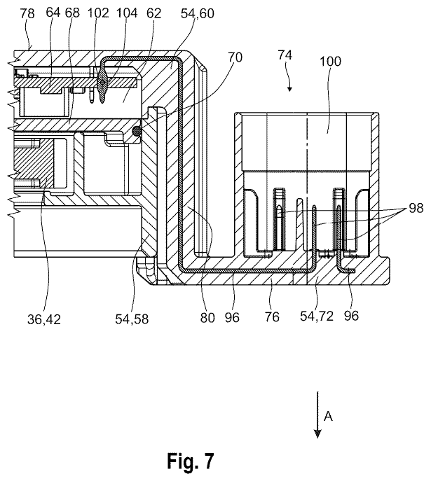

The electrical connection 74 has a plurality of connection contacts 96 (see FIG. 7), each of which projects with a connection end 98 into a connection geometry 100 of the connection housing 72.

In this context, the connection geometry 100 is complementary to a connector (not shown) via which the actuator assembly 10 is connected, for example, to an on-board computer of the vehicle.

Of course, the connection geometry 100 can alternatively be complementary to a connection socket via which the actuator assembly 10 is connected to the vehicle. In this case, the socket portion 76 is correspondingly designed as a plug-in portion having such a connection geometry 100.

The connection contacts 96 extend from their connection end 98 through the socket portion 76, the axial web 80 and the housing cover 60 into the chamber 62, in which they are connected in a signal-transmitting manner to the printed circuit board 64.

In the manufacture of the housing cover 60, the connection contacts 96 are, for example, overmoulded with plastic.

In the present embodiment, the connection contacts 96 have push-in press-fit contacts 102, which project from the housing cover 60 and are connected in a signal-transmitting manner to the printed circuit board 64 via complementary contact holes 104 in the printed circuit board 64.

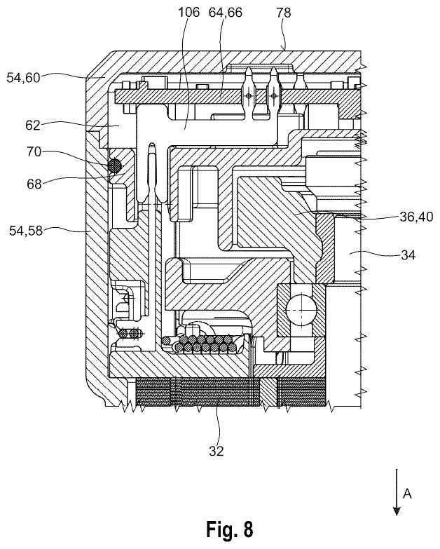

The printed circuit board 64 is in turn connected in a current-carrying manner to the electric motor 32 via axial electrical plug-in contacts 106 (see FIG. 8) and is thus controllable via the printed circuit board 64.

In this way, there is provided an actuator assembly 10 that is particularly compact and can be manufactured with a low outlay.

1. Actuator assembly for an electromechanical vehicle brake, having
a brake calliper in which an intermediate space for a brake rotor is formed, wherein a brake lining, which can be applied to the brake rotor,, is arranged in the intermediate space,
a spindle drive, which has a spindle sleeve, a spindle nut and a drive shaft, driven by an electric motor, for adjusting the spindle nut in the axial direction via the spindle sleeve, wherein the spindle nut can be moved between an extended and a retracted position by means of axial adjustment,
a brake housing, which forms the brake calliper and inside which the spindle drive is arranged, and an actuator housing, which is connected to the brake housing,
wherein the drive shaft is coupled on the one hand to the spindle sleeve via a reduction gear mechanism and on the other hand to a motor shaft of an electric motor via a gear unit with spur gears, wherein all the spur gears are arranged in a common plane, and
wherein the gear unit is arranged inside the actuator housing.

2. Actuator assembly according to claim 1, wherein, in at least one position of the spindle nut, the reduction gear mechanism is arranged at least partially inside the spindle nut and/or the spindle sleeve in the axial direction.

3. Actuator assembly according to claim 1, wherein the reduction gear mechanism is a tungsten gear mechanism, an eccentric gear mechanism or a cycloidal gear mechanism.

4. Actuator assembly according claim 1, wherein the gear unit is a spur gear mechanism or a belt gear mechanism.

5. Actuator assembly according to claim 1, wherein a printed circuit board is arranged inside the actuator housing said printed circuit board forming a control device of the actuator assembly.

6. Actuator assembly according to claim 5, wherein a partition wall is arranged inside the actuator housing, said partition wall separating the printed circuit board from the gear unit and the electric motor in an air-tight manner.

7. Actuator assembly according to claim 6, wherein the partition wall is connected to the actuator housing via a seal.

8. Actuator assembly according to claim 5, wherein the actuator housing has a housing body and a housing cover, which is attached to the housing body and to which the printed circuit board is fastened.

9. Actuator assembly according to claim 8, wherein the actuator housing has a connection housing, connected in one piece to the housing cover, of an electrical connection, wherein the electrical connection has connection contacts, which are connected in a signal-transmitting manner to the printed circuit board and extend through the housing cover and the connection housing into a connection geometry of the connection housing.

10. Actuator assembly according to claim 9, wherein the connection housing is arranged on a peripheral wall of the housing cover and in the axial direction between an outer end face of the housing cover and the spindle drive.

11. Actuator assembly according to claim 9, wherein the connection housing is connected to the housing body via a plug-in geometry, which forms a rotation prevention means between the connection housing and the housing body.

12. Actuator assembly according to claim 11, wherein the plug-in geometry has at least one rib extending in the axial direction and a groove of complementary shape into which the rib engages positively.

13. Actuator assembly according to claim 12, wherein the plug-in geometry has two grooves with their open sides facing each other, into which the respective associated rib engages positively.
